(19) United States
(12) Patent Application Publication
(10) Pub. No.: US 2023/0154149 A1
(43) Pub. Date: May 18, 2023

(54) Computer Methods and Interfaces for Efficient Categorization of Voluminous Data

(71) Applicant: MAD STREET DEN, INC., REDWOOD CITY, CA (US)

(72) Inventors: Anand CHANDRASEKARAN, Chennai (IN); Ramanathan L, Aranthangi (IN); Srinath K, Coimbatore (IN); Vishnu Deva KR, Chennai (IN); Sanaa SYED, Lucknow (IN); Niranjan MUJUMDAR, Mumbai (IN); Shivaraman SHANKAR, Chennai (IN); Athul S ATHREYA, Chennai (IN); Anuradha GOPAL, Chennai (IN); Chirag Umesh BAJAJ, Ahmedabad (IN)

(73) Assignee: MAD STREET DEN, INC., REDWOOD CITY, CA (US)

(21) Appl. No.: 17/946,958

(22) Filed: Sep. 16, 2022

(30) Foreign Application Priority Data
Sep. 16, 2021 (IN) 202141041955

(51) Int. Cl. G06V 10/762

(52) U.S. Cl. CPC G06V 10/762

(57) ABSTRACT

Computer-aided categorization or classification of numerous data records can be controlled and guided through a user interface that accepts user input to produce clustering training data, and that conveys the improved automatic classification results efficiently to the user. Features that facilitate working with thousands or millions of data records are described and claimed.

### CONTINUITY AND CLAIM OF PRIORITY

This is an original U.S. utility patent application that claims priority to Indian provisional patent application no. 202141041955 filed 16 Sep. 2021.

### FIELD

The invention relates to human-computer user interfaces. More specifically, the invention relates to display techniques, user interactions and automation functions to amplify a computer user's effectiveness and reduce the time required to perform certain operations.

### BACKGROUND

Computers function as effort-multipliers for many human activities, in similar fashion to levers or hydraulics configured as force multipliers to allow an individual to move heavy objects. Some computer tasks are largely autonomous: once the user has set up the problem, the computer calculates or iterates (perhaps for hours or days) to find the answer. Other tasks are highly interactive: the user manipulates an interface peripheral to change a parameter, and the computer provides an updated display showing the effect of the change in real time.

Certain computer-aided applications require a blend of these qualities: the data or calculations are so voluminous that the task cannot be completed in real time; yet specifying the task completely so that the computations can be conducted without further interaction is impractical—the user needs to provide interactive feedback as the work proceeds so that the computer can produce a useful result. One important example of a task like this is categorizing or classifying data records. A record may simply be an image, and the task is grouping images into two or more clusters by characteristics such as image subject, color, presence or absence of a particular feature, etc. However, “data records” may comprise a variety of types of information, including qualitative and quantitative fields, and the task may be to group the records by time, location, ranges of values, or other characteristics and combinations of characteristics.

“Classification” problems are a good fit for machine-learning (“ML”) techniques, but it can be challenging to guide the learning process so that it can distinguish and classify data records accurately on the bases desired. Computer/user interface features and techniques that facilitate ML training so that domain experts (rather than computer or machine-learning experts) can perform the training may be of substantial value in this area.

### SUMMARY

Embodiments of the invention are computer interface techniques for presenting information to a user and receiving feedback therefrom, and applying the user feedback to adjust a machine-learning algorithm to improve the accuracy of a data classification operation being performed by the computer.

### BRIEF DESCRIPTION OF DRAWINGS

FIG. 1 shows a computer user-interface where an embodiment of the invention is in use.

FIG. 2 shows the user interface after the user has provided real-time feedback about a classification task.

FIG. 3 shows additional computer-executed classification updates that may be performed by the embodiment.

FIG. 4 shows a possible final configuration of the user interface after an operator action and subsequent automatic actions triggered by the operator action.

FIG. 5 is a flow chart outlining the operations of an embodiment of the invention.

### DETAILED DESCRIPTION

Classification or clustering problems require workers or computers to separate data records into two or more groups on the basis of some or all of the data in each record. Example problems involving classifying images are familiar to readers and provide easy-to-understand scenarios that illustrate how embodiments of the invention may operate. A simple image-classification problem is to determine—for each image of a plurality of images—whether the image depicts a particular object. For example, given a large number of images, one may wish to know whether the image contains a vehicle. Or, one may wish to separate images of cats from images of dogs.

Even binary classification problems (contains vehicle/does not contain vehicle or dog/cat) may exhibit unexpected complexity (is a snowmobile a vehicle? Is a picture of an otter more like a dog or a cat?) But practical classification problems often involve more than two clusters. For example, the “vehicle” classification may actually require “car,” “truck,” “aircraft,” and “watercraft.” “Dog/cat” may include classifications for “both” or “neither.” The person who has the data and the desire to classify it may be in the best position to specify the categories desired.

A variety of computer-implemented algorithms exist to perform classification, categorization or clustering. These must generally be provided with sample data records that have already been classified as desired. The algorithms analyze the training data to discern the features that seem to be important in grouping the records, and can thereafter evaluate new records of similar form to place them in a category. The automatic classification often produces a confidence level as well, indicating how likely the classification is to be correct. As training proceeds, it is often the low confidence classifications that are most important: by providing a human-chosen classification for a particular data record that the algorithm was not able to classify confidently, the algorithm can update its parameters to accommodate ambiguous records.

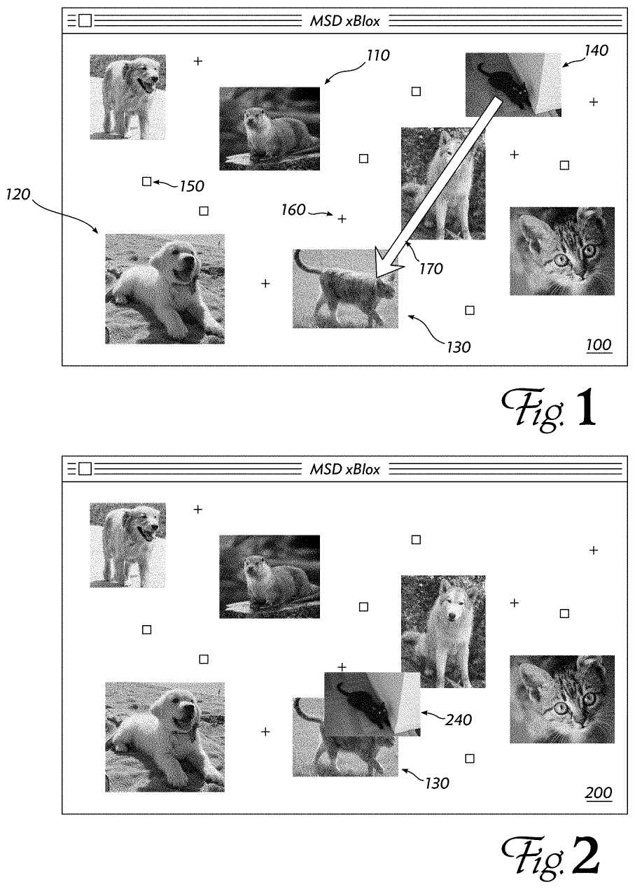

FIG. 1 shows a representative two-dimensional user interface screen 100 where an embodiment of the invention can operate. A rectangular display area or “canvas” presents a number of representative data records 110, 120, 130, 140 from a data set (in this example, the records are images of animals). In addition, symbols 150 and 160 may be displayed. These symbols represent other data records or pluralities of data records that the display area is too small to depict in full. Embodiments of the invention are often used with data sets comprising millions or billions of records, so these symbols may stand in for vastly more records than the number of fully-displayed representative records. The user indicates that data record 140 should be grouped with data record 130 by a conventional user-interface gesture such as “click-and-drag” 170.

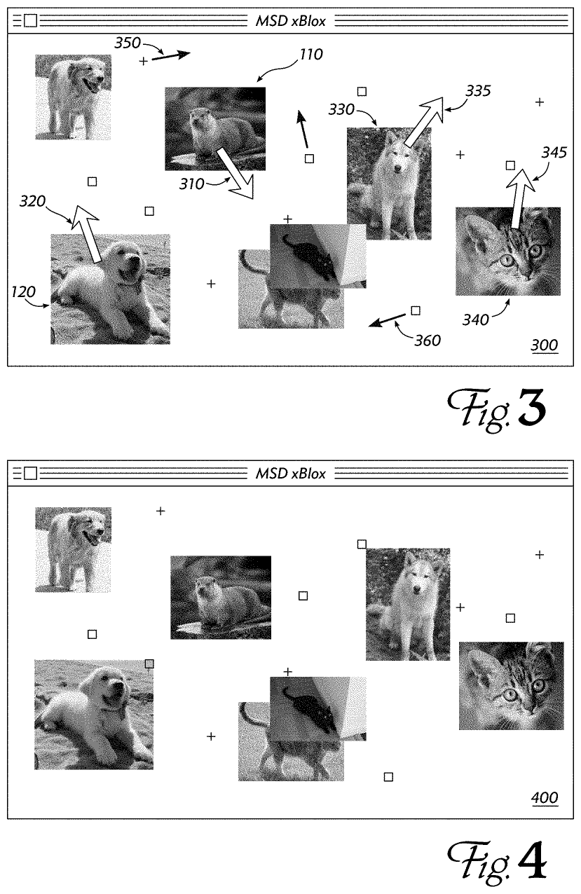

The display area is updated as shown in FIG. 2, 200: image 140 is now placed at 240, near image 130.

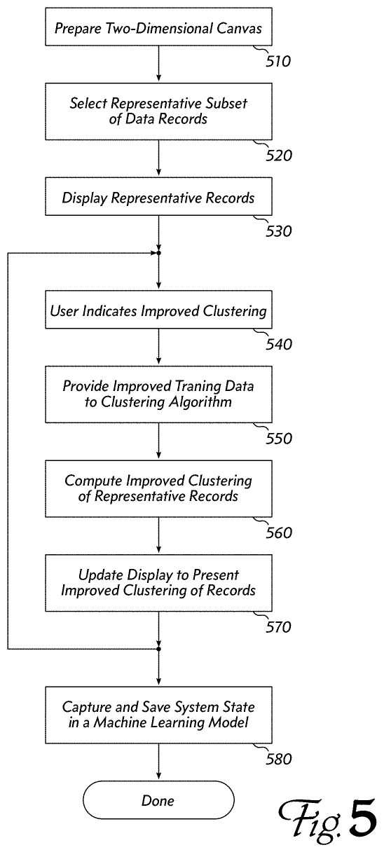

The embodiment performs some operations to be discussed presently, which may have no visible effect on the display area, but when the operations are complete, the display may be updated as shown in FIG. 3, 300: data record 110 is moved 310; data record 120 is moved 320; data record 330 is moved 335; and data record 340 is moved 345. Multi-record symbols may also be repositioned as shown at 350 and 360. This results in the fully-updated screen shown in FIG. 4, 400. In an embodiment of the invention, an affirmative user-interface action such as FIG. 1, 170 may result in some or all of the data records represented by the interface being moved as well.

The user can make further groupings or adjustments to improve the displayed record clustering, and the system automatically makes corresponding adjustments of some or all of the other data records, until a properly-classified or -clustered configuration is reached.

FIG. 5 is a flow chart outlining the visible and invisible operations of an embodiment. First, a two-dimensional display area or canvas is prepared (510). Next, a representative subset of data records from the data set is selected (520). The representative records are displayed (530). As explained above, symbols representing one or more other data records may also be displayed.

The user performs standard interactive actions on single records or on symbols representing groups of records to indicate an improved clustering configuration over the presently-displayed arrangement (540). (When the nature of the data requires visual feedback to the user for manipulating multiple-record symbols, the UI may briefly display “thumbnails” or other indications when a symbol is manipulated.) Information about the improved clustering configuration is provided as new training data to a computer-implemented data-record clustering algorithm (550), which may update its parameters so that it can compute a better clustering of some or all of the data records.

The updated clustering algorithm computes an improved clustering of the representative records (560), and this information is used to update the display (570). The final step may cause some or all of the displayed data records and symbols to be moved on the display, even though the user had not interacted with them.

The user may interact with the user interface further, by moving any of the displayed data records, and the other records and symbols may further migrate toward an overall improved clustering. As the clustering algorithm performance improves due to the provision of user-indicated training cases, the displayed data records will be grouped more closely according to the desired classification, and new representative data records may be inserted to fill empty space where older representative data records have migrated away. The system may choose new representative data records for this purpose from among records that have a low clustering confidence value—essentially, the system will prompt the user to categorize data records that the system cannot categorize confidently on the basis of its then-extant training.

In addition, the symbols representing undisplayed data records may change in size or type to suggest the quantity of such records and where the system's automatic categorization has determined they should be placed. If the user wishes to examine this automatic categorization, she may interact with a symbol and some representative data records from the group associated with the symbol may be displayed in full. The user may interact with these new representative data records to provide additional feedback and control of the clustering algorithm.

After a user-interface session is complete, the system captures and saves state information in a Machine Learning model so that future sessions can resume where a previous session left off (580).

An embodiment of the invention may be a machine-readable medium, including without limitation a non-transient machine-readable medium, having stored thereon data and instructions to cause a programmable processor to perform operations as described above. In other embodiments, the operations might be performed by specific hardware components that contain hardwired logic. Those operations might alternatively be performed by any combination of programmed computer components and custom hardware components.

Instructions for a programmable processor may be stored in a form that is directly executable by the processor (“object” or “executable” form), or the instructions may be stored in a human-readable text form called “source code” that can be automatically processed by a development tool commonly known as a “compiler” to produce executable code. Instructions may also be specified as a difference or “delta” from a predetermined version of a basic source code. The delta (also called a “patch”) can be used to prepare instructions to implement an embodiment of the invention, starting with a commonly-available source code package that does not contain an embodiment.

In some embodiments, the instructions for a programmable processor may be treated as data and used to modulate a carrier signal, which can subsequently be sent to a remote receiver, where the signal is demodulated to recover the instructions, and the instructions are executed to implement the methods of an embodiment at the remote receiver. In the vernacular, such modulation and transmission are known as “serving” the instructions, while receiving and demodulating are often called “downloading.” In other words, one embodiment “serves” (i.e., encodes and sends) the instructions of an embodiment to a client, often over a distributed data network like the Internet. The instructions thus transmitted can be saved on a hard disk or other data storage device at the receiver to create another embodiment of the invention, meeting the description of a non-transient machine-readable medium storing data and instructions to perform some of the operations discussed above. Compiling (if necessary) and executing such an embodiment at the receiver may result in the receiver performing operations according to a third embodiment.

In the preceding description, numerous details were set forth. It will be apparent, however, to one skilled in the art, that the present invention may be practiced without some of these specific details. In some instances, well-known structures and devices are shown in block diagram form, rather than in detail, in order to avoid obscuring the present invention.

Some portions of the detailed descriptions may have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the preceding discussion, it is appreciated that throughout the description, discussions utilizing terms such as “processing” or “computing” or “calculating” or “determining” or “displaying” or the like, refer to the action and processes of a computer system or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, including without limitation any type of disk including floppy disks, optical disks, compact disc read-only memory (“CD-ROM”), and magnetic-optical disks, read-only memories (ROMs), random access memories (RAMs), eraseable, programmable read-only memories (“EPROMs”), electrically-eraseable read-only memories (“EEPROMs”), magnetic or optical cards, or any type of media suitable for storing computer instructions.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will be recited in the claims below. In addition, the present invention is not described with reference to any particular programming language. It will be appreciated that a variety of programming languages may be used to implement the teachings of the invention as described herein.

The applications of the present invention have been described largely by reference to specific examples and in terms of particular allocations of functionality to certain hardware and/or software components. However, those of skill in the art will recognize that human-directed training to assist a machine-learning classification algorithm can also be produced by software and hardware that distribute the functions of embodiments of this invention differently than herein described. Such variations and implementations are understood to be captured according to the following claims.

We claim:

1. A user interface for training a machine-learning algorithm to classify a multitude of data records into a plurality of similar clusters, comprising:
preparing a two-dimensional display area;
selecting a representative subset of the multitude of data records;
displaying representative images corresponding to the representative subset on the two-dimensional display area;
receiving user input to indicate that a first representative image should be clustered with a second representative image;
amending a clustering algorithm according to the user input to produce an amended clustering algorithm;
applying the amended clustering algorithm to the representative subset to produce an improved clustering;
adjusting a position of the representative images besides the first representative image and the second representative image to reflect the improved clustering.

2. The user interface of claim 1, wherein the plurality of similar clusters is two similar clusters.

3. The user interface of claim 1, wherein a count of the plurality of similar clusters is between three similar clusters and ten similar clusters.

4. The user interface of claim 1, further comprising:
displaying abridged symbols on the two-dimensional display area, each abridged symbol to represent at least one data record of the multitude of data records that is not a member of the representative subset;
applying the amended clustering algorithm to data records represented by the abridged symbols; and
adjusting a position of the abridged symbols to reflect the improved clustering.
